(19) United States
(12) Patent Application Publication
(10) Pub. No.: US 2006/0072197 A1
(43) Pub. Date: Apr. 6, 2006

(54) Optical laminate and optical element

(75) Inventors: Yukimitsu Iwata, Tokyo-To (JP); Koichi Mikami, Tokyo-To (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 11/232,449

(22) Filed: Sep. 21, 2005

(30) Foreign Application Priority Data
Sep. 30, 2004 (JP) 2004-287986

(51) Int. Cl. G02B 5/122

(52) U.S. Cl. 359/529

(57) ABSTRACT

There is provided an optical element that, even when a transparent base material is formed of triacetylcellulose, is in a boat bottom form in section and has streaks, can realize the formation of an anti-dazzling layer in a stable and efficient manner and can realize the control of optical characteristics with higher accuracy. There is also provided an optical laminate comprising: a transparent base material; and an anti-dazzling layer provided on a surface of the transparent base material through a smoothing transparent resin layer for smoothing the surface of the transparent base material, characterized in that the transparent base material consists essentially of triacetylcellulose, the thickness of the smoothing transparent resin layer is regulated to fall within a range of 0.5 to 2.0 μm, and the smoothing transparent resin layer is provided directly on the transparent base material without through any other layer. The optical element comprises the optical laminate.

### TECHNICAL FIELD

The present invention relates to an optical laminate and an optical element comprising this optical laminate. More particularly, the present invention relates to an optical laminate comprising a transparent base material and an anti-dazzling layer provided on the transparent base material through a smoothing transparent resin layer for smoothing the surface of the transparent base material, and an optical element.

### BACKGROUND ART

For example, liquid crystal display devices such as display monitors, televisions, and car navigation, and electroluminescent display devices are formed of optical laminates such as light diffusing films, lens films, polarizing films, view angle regulation films, antireflection films, anti-dazzling films, touch panels, scratch-resistant hardcoats, and films having, on a surface thereof, fine concaves and convexes for optical adhesion-derived Newton's ring preventive purposes (anti-Newton film). From the viewpoints of weight reduction and thickness reduction, many of these optical laminates are formed of plastic materials. For example, Japanese Patent Laid-Open No. 18706/1994 describes a laminate structure comprising an antistatic layer and an anti-dazzling layer provided on a transparent substrate.

### DISCLOSURE OF THE INVENTION

A film-like triacetylcellulose is used as a transparent base material in the above optical laminates, from the viewpoints of high transparency and freedom from birefringence. In general, in order to prevent the occurrence of blocking upon winding in the form of a roll of a continuous film, the triacetylcellulose film is formed in the so-called boat bottom shape in which both side parts in the width-wise direction are thick and the thickness of the center part is smaller than both side parts. On the other hand, for the triacetylcellulose film, in many cases, apart from the boat bottom shape, fine streaks take place in a flow direction over the whole width of the film due to the influence of lip during stretching.

For example, an anti-dazzling layer is provided on the transparent base material formed of triacetylcellulose. In this case, problems sometimes occur including that difficulties are encountered in forming the anti-dazzling layer by coating and the desired optical characteristics are not obtained.

In recent years, an increase in size and market expansion of display pannels have led to increased size and increased accuracy in various electronic elements which have led to a demand for large optical laminates that are free from steaks and unevenness or the like and have uniform quality.

The present inventors have found that one of major causes of planar defects such as streaks and unevenness in optical laminates having an anti-dazzling layer is substantially derived from the form and deformation of the triacetylcellulose film per se. They are not attributable to a coating method for anti-dazzling layer formation and drying conditions but are correlated with the form and deformation of the triacetylcellulose base material.

According to the present invention, the above problems posed mainly from the boat bottom shape of the triacetylcellulose and the presence of streaks on the surface of the triacetylcelluose can be solved by forming a smoothing transparent resin layer on a surface of the base material to once smoothen the surface of the base material and then forming the anti-dazzling layer.

Thus, according to the present invention, there is provided an optical laminate comprising: a transparent base material; and an anti-dazzling layer provided on a surface of the transparent base material through a smoothing transparent resin layer for smoothing the surface of the transparent base material, characterized in that said transparent base material essentially comprises triacetylcellulose, the thickness of the smoothing transparent resin layer is regulated to fall within a range of 0.5 to 2.0 μm, and the smoothing transparent resin layer is provided directly on the transparent base material without through any other layer.

In a preferred embodiment of the optical laminate according to the present invention, said smoothing transparent resin layer essentially comprises one or at least two resins selected from polyester resins, polyether resins, acrylic resins, epoxy resins, urethane resins, alkyd resins, spiroacetal resins, polybutadiene resins, and polythiol-polyene resins.

In a preferred embodiment of the optical laminate according to the present invention, said smoothing transparent resin layer has been formed by coating the smoothing transparent resin on a surface of the transparent base material and then curing the coated smoothing transparent resin through the action of an ionizing radiation.

In a preferred embodiment of the optical laminate according to the present invention, said anti-dazzling layer comprises inorganic or organic fine particles dispersed in a cured product of an ionizing radiation curing resin composition.

In a preferred embodiment of the optical laminate according to the present invention, a lower-refractive index layer is further provided on the anti-dazzling layer.

Further, according to the present invention, there is provided an optical element comprising the above optical laminate.

Furthermore, according to the present invention, there is provided a polarizing plate comprising a polarizing element and the above optical laminate provided on a surface of the polarizing element so that the optical laminate on its side remote from the anti-dazzling layer faces the polarizing element.

Furthermore, according to the present invention, there is provided an image display device characterized by comprising a light transparent display and a light source device for illuminating the light transparent display from its backside, the above optical laminate or the above polarizing plate being stacked on a surface of the light transparent display.

The optical laminate according to the present invention comprises: a transparent base material; and an anti-dazzling layer provided on a surface of the transparent base material through a smoothing transparent resin layer for smoothing the surface of the transparent base material, wherein said transparent base material comprises triacetylcellulose, the thickness of the smoothing transparent resin layer is regulated to fall within a range of 0.5 to 2.0 μm, and the smoothing transparent resin layer is provided directly on the transparent base material without through any other layer. By virtue of this construction, even when the transparent base material is formed of triacetylcellulose and is of a boat bottom shape in section and has streaks, the optical laminate does not suffer from problems including, for example, that difficulties are encountered in coating the anti-dazzling layer and the desired optical characteristics cannot be obtained.

Accordingly, the anti-dazzling layer can be formed more stably at a high speed with high efficiency, and, thus, even large optical elements can be efficiently produced. Further, the optical characteristics of the optical element can also be controlled more stably with higher accuracy.

### BRIEF DESCRIPTION OF THE DRAWING

FIG. 1 is a cross-sectional view showing one preferred embodiment of the optical laminate according to the present invention.

### BEST MODE FOR CARRYING OUT THE INVENTION

As described above, the optical laminate according to the present invention comprises: a transparent base material; and an anti-dazzling layer provided on a surface of the transparent base material through a smoothing transparent resin layer for smoothing the surface of the transparent base material, wherein said transparent base material consists essentially of triacetylcellulose, the thickness of the smoothing transparent resin layer is regulated to fall within a range of 0.5 to 2.0 μm, and the smoothing transparent resin layer is provided directly on the transparent base material without through any other layer.

The present invention will be described in conjunction with the accompanying drawings. However, the present invention is not limited thereto.

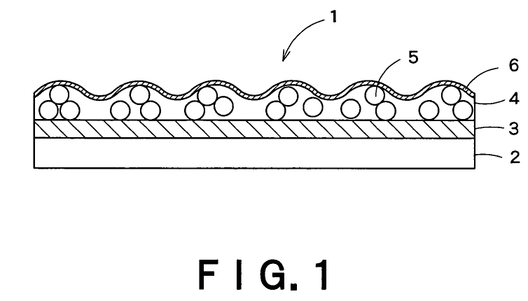

FIG. 1 is a cross-sectional view showing one preferred embodiment of the optical laminate according to the present invention. In FIG. 1, numeral 1 designates the optical laminate according to the present invention, numeral 2 a transparent substrate, numeral 3 a smoothing transparent resin layer, numeral 4 an anti-dazzling layer, numeral 5 fine particles present in the anti-dazzling layer 4, and numeral 6 a lower-refractive index layer.

The transparent base material 2 according to the present invention consists essentially of triacetylcellulose. The thickness of the transparent base material 2 may be properly varied depending upon the type, size, and particular applications of the optical element. In general, however, the thickness of the transparent base material 2 is about 25 to 1000 μm, preferably 40 to 80 μm. As described above, the triacetylcellulose film is generally formed in the form of the so-called “boat bottom shape” in which both side parts in the width-wise direction are thick and the thickness of the center part is smaller than both side parts, and fine streaks are present over the whole film width. The transparent base material constituting the optical laminate according to the present invention may be this transparent base material formed of a triacetylcellulose film which is of boat bottom shape and has fine streaks.

Further, in the present invention, the anti-dazzling layer 4 is provided on the transparent base material 2 through a smoothing transparent resin layer 3. The thickness of the smoothing transparent resin layer 3 is regulated so as to fall within a thickness range of 0.5 to 2.0 μm, and this smoothing transparent resin layer 3 is provided directly on the transparent base material 2 without through any other layer.

In the present invention, since the smoothing transparent resin layer having a specific thickness is provided directly on the transparent base material without through any other layer, even when the transparent base material formed of triacetylcellulose, which, as described above, is of a boat bottom shape and has streaks, problems do not occur including, for example, that difficulties are encountered in coating the anti-dazzling layer and the desired optical characteristics are not obtained.

The smoothing transparent resin layer has a thickness of 0.5 to 2.0 μm, preferably 0.8 to 1.6 μm. When the thickness is less than 0.5 μm, the triacetylcellulose base material cannot be satisfactorily smoothened without difficulties. On the other hand, when the thickness of the smoothing transparent resin layer is larger than 2.0 μm, there is a fear of undergoing the influence of curling or causing interfacial peeling between individual constituent layers.

The smoothing transparent resin layer 3 can be formed of various transparent resins. In the present invention, the smoothing transparent resin layer 3 may be formed of, for example, resins which have hitherto been used in the optical field, preferably ionizing radiation curing resins. Specific examples of preferred ionizing radiation curing resins usable herein include acrylate functional group-containing resins, for example, relatively low-molecular weight polyester resins, polyether resins, acrylic resins, epoxy resins, urethane resins, alkyd resins, spiroacetal resins, polybutadiene resins, polythiol-polyene resins, oligomers or prepolymers of (meth)acrylate or the like of polyfunctional compounds, such as polyhydric alcohols, and those containing a relatively large amount of a reactive diluent, such as a monofunctional monomer, such as ethyl (meth)acrylate, ethylhexyl (meth)acrylate, styrene, methylstyrene, or N-vinylpyrrolidone, and a polyfunctional monomer, for example, trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, or neopentyl glycol di(meth)acrylate.

Among them, a mixture of a polyester acrylate with polyurethane acrylate is particularly preferred. In order to bring the above ionizing radiation curing resin composition to an ultraviolet curing resin composition, it is possible to incorporate, into the ionizing radiation curing resin composition, a photopolymerization initiator, such as an acetophenone compound, a benzophenone compound, Michler's benzoylbenzoate, an α-amyloxime ester, tetramethyl thiuram monosulfide, or a thioxanthone compound, and a photosensitizer, such as n-butylamine, triethylamine, or tri-n-butylphosphine. In the present invention, it is particularly preferred to incorporate urethane acrylate or the like as an oligomer and dipentaerythritol hexaacrylate or the like as a monomer.

In order to bring the above ionizing radiation curing resin composition to an ultraviolet curing resin composition, it is possible to incorporate, into the ionizing radiation curing resin composition, a photopolymerization initiator, such as an acetophenone compound, a benzophenone compound, Michler's benzoylbenzoate, an α-amyloxime ester, tetramethyl thiuram monosulfide, or a thioxanthone compound, and a photosensitizer, such as n-butylamine, triethylamine, or tri-n-butylphosphine. In the present invention, it is particularly preferred to incorporate urethane acrylate or the like as an oligomer and dipentaerythritol hexaacrylate, 1,6-hexanediol diacrylate or the like as a monomer.

This smoothing transparent resin layer 3 may be formed by preparing a coating liquid as a solution or dispersion of an ionizing radiation curing resin composition for smoothing transparent resin layer formation, a photo polymerization initiator and other materials, coating the coating liquid onto the transparent substrate formed of triacetylcellulose, and then applying an ionizing radiation to the coating to cure the coating.

In the present invention, the anti-dazzling layer 4 is formed on the smoothing transparent resin layer 3. In the present invention, the anti-dazzling layer 4 may be formed of a dispersion of inorganic or organic fine particles 5 for imparting anti-dazzling properties to the transparent resin materials. Transparent resin materials for constituting the anti-dazzling layer 4 include various transparent resins, for example, resins which have hitherto been used in the optical field, preferably ionizing radiation curing resins. Specific examples of preferred ionizing radiation curing resins usable herein include acrylate functional group-containing resins, for example, relatively low-molecular weight polyester resins, polyether resins, acrylic resins, epoxy resins, urethane resins, alkyd resins, spiroacetal resins, polybutadiene resins, polythiol-polyene resins, oligomers or prepolymers of (meth)acrylate or the like of polyfunctional compounds, such as polyhydric alcohols, and those containing a relatively large amount of a reactive diluent, such as a monofunctional monomer, such as ethyl (meth)acrylate, ethylhexyl (meth)acrylate, styrene, methylstyrene, or N-vinylpyrrolidone, and a polyfunctional monomer, for example, trimethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, or neopentyl glycol di(meth)acrylate.

Inorganic fine particles for imparting anti-dazzling properties to the transparent resin materials include, for example, silica and alumina. Preferred organic fine particles include resin beads having a refractive index of 1.40 to 1.60. The reason why the refractive index of the resin beads is limited to this value range is that, since the refractive index of the ionizing radiation curing resin, particularly the refractive index of the acrylate or methacrylate resin is generally 1.40 to 1.50, when resin beads having a refractive index, which is close to the refractive index of the ionizing radiation curing resin as much as possible are selected, the anti-dazzling properties can be enhanced without sacrificing the transparency of the coating film. Specific examples of preferred resin beads having a refractive index close to the ionizing radiation curing resin include polymethyl methacrylate beads (refractive index: 1.49), polycarbonate beads (refractive index: 1.58), polystyrene beads (refractive index: 1.60), polyacrylstylene beads (refractive index: 1.57), and polyvinyl chloride beads (refractive index: 1.54).

The particle diameter of the resin beads is suitably 3 to 8 μm, and the amount of the resin beads used is 5 to 22 parts by weight, generally about 15 parts by weight, based on 100 parts by weight of the resin. When such resin beads are incorporated into the coating composition, the resin beads settled on the bottom of a vessel containing the coating composition during coating should be sufficiently dispersed by stirring. In order to eliminate such inconvenience, silica beads having a particle diameter of not more than 0.5 μm, preferably 0.1 to 0.25 μm, may be incorporated as an anti-settling agent for the resin beads into the coating liquid. The effect of preventing the settling of the organic filler becomes better with increasing the amount of the silica beads. However, the addition of the silica beads in an excessive amount adversely affects the transparency of the coating. For this reason, it is preferably less than about 0.1 part by weight based on 100 parts by weight of the resin because the settling of the organic filler can be prevented without substantially sacrificing the transparency of the coating as the anti-dazzling layer.

The above transparent resin material for constituting the anti-dazzling layer may if necessary contain other materials such as antistatic agents and leveling agents.

Such antistatic agents usable herein include inorganic fillers, for example, metallic fillers, tin oxide and indium oxide. Inorganic fillers having a particle diameter which is equal to or smaller than the wavelength of visible light are particularly preferred, because, upon curing, they become transparent and thus is not detrimental to the transparency of the anti-dazzling film.

Organic antistatic agents include, for example, various surfactant-type antistatic agents, for example, cationic group-containing various cationic antistatic agents such as quaternary ammonium salts, pyridinium salts, and primary to tertiary amino groups, anionic group-containing anionic antistatic agents such as sulfonic acid bases, sulfuric ester bases, phosphoric ester bases, and phosphonic acid bases, amphoteric antistatic agents such as amino acid and amino sulfuric ester antistatic agents, nonionic antistatic agents such as aminoalcohol, glycerin, and polyethylene glycol surfactants, and, further, polymer-type antistatic agents prepared by increasing the molecular weight of the above antistatic agents. Further, polymerizable antistatic agents, for example, monomers or oligomers which contain tertiary amino or quaternary ammonium groups and are polymerizable by an ionizing radiation, for example, N,N-dialkylaminoalkyl (meth)acrylate monomers and quaternary compounds thereof, may also be used.

Thus, when the antistatic agent is added to the anti-dazzling material, an anti-dazzling film formed by coating this anti-dazzling coating material is free from the generation of static electricity and, thus, is free from adherence of dust by static electricity. Further, when the anti-dazzling film is incorporated in liquid crystal displays or the like, there is no fear of undergoing external static electric interference.

The addition of a fluoro or silicone leveling agent as the leveling agent to an ionizing radiation curing resin is advantageous for curing. The reason for this is that, in general, when triacetylcellulose is used as a transparent substrate, since the irradiation intensity of ultraviolet light cannot be increased to a high level due to poor heat resistance, the hardness of the surface of the coating film is unsatisfactory. In the ionizing radiation curing resin with a leveling agent added thereto, however, since a fluoro or silicone leveling agent bleeds at the interface of the coating film and air during drying to remove the solvent, the inhibition of curing of the ultraviolet curing resin by oxygen can be prevented. This is because, even when the irradiation intensity of the ultraviolet light is low, a cured coating film having satisfactory hardness can be formed.

The thickness of the anti-dazzling layer is 2.0 to 10.0 μm, preferably 3.0 to 6.0 μm.

If necessary, a lower-refractive index layer 6 may be formed on the anti-dazzling layer 4.

The refractive index of the lower-refractive index layer 6 according to the present invention is preferably 1.30 to 1.50, more preferably 1.30 to 1.45. The lower the refractive index, the lower the reflectance and, thus, the better the results. However, when the refractive index is lower than 1.30, the strength as the lower-refractive index layer is unsatisfactory and, thus, the use of the film as the antireflection film which is used on the outermost surface is unfavorable.

The thickness of the optical thin film of the lower-refractive index layer 6 preferably satisfies mathematical formula (I) from the viewpoint of reducing reflectance.
(m/4)×0.7<n₁d₁<(m/4)×1.3 (I)
wherein m is a positive odd number; n₁ represents the refractive index of the lower-refractive index layer; d₁ represents the thickness of the lower-refractive index layer, nm; and λ represents the wavelength and is a value in the range of 500 to 550 nm.

The wording “satisfies mathematical formula (I)” means that m (a positive odd number, generally 1) satisfying mathematical formula (I) is present in the above wavelength range.

The lower-refractive index layer 6 is formed of any of a fluororesin as a low-refractive index resin, empty silica- or magnesium fluoride-containing transparent resin, and an empty silica- or magnesium fluoride-containing fluororesin, has a refractive index of not more than 1.45, and is in the form of an optical thin film, or is in the form of a thin film formed by chemical vapor deposition or physical vapor deposition of silica or magnesium fluoride.

More preferably, the lower-refractive index layer 6 may be formed of a silicone-containing vinylidene fluoride copolymer. The silicone-containing vinylidene fluoride copolymer is specifically prepared by copolymerization using a monomer composition comprising 30 to 90% of vinylidene fluoride and 5 to 50% of hexafluoropropylene (% being by mass; the same shall apply hereinafter) as a starting material. The resin composition comprises 100 parts of a fluorocopolymer having a fluorine content of 60 to 70% and 80 to 150 parts of an ethylenically unsaturated group-containing polymerizable compound. This resin composition is used to form a lower-refractive index layer 6 in the form of a thin film having a thickness of not more than 200 nm to which scratch resistance has been imparted and which has a refractive index of less than 1.60 (preferably not more than 1.46).

In the silicone-containing vinylidene fluoride copolymer constituting the lower-refractive index layer 6, regarding the proportions of individual components in the monomer composition, the content of vinylidene fluoride is 30 to 90%, preferably 40 to 80%, particularly preferably 40 to 70%, and the content of hexafluoropropylene is 5 to 50%, preferably 10 to 50%, particularly preferably 15 to 45%. This monomer composition may further contain 0 to 40%, preferably 0 to 35%, particularly preferably 10 to 30%, of tetrafluoroethylene.

The monomer composition may contain other comonomer component in such an amount that is not detrimental to the purpose of use and effect of the silicone-containing vinylidene fluoride copolymer, for example, not more than 20%, preferably not more than 10%. Specific examples of such other comonomer components usable herein include fluorine atom-containing polymerizable monomers such as fluoroethylene, trifluoroethylene, chlorotrifluoroethylene, 1,2-dichloro-1,2-difluoroethylene, 2-bromo-3,3,3-trifluoroethylene, 3-bromo-3,3-difluoropropylene, 3,3,3-trifluoropropylene, 1,1,2-trichloro-3,3,3-trifluoropropylene, and α-trifluoromethacrylic acid.

The fluorocopolymer produced from the above monomer composition should have a fluorine content of 60 to 70%, preferably 62 to 70%, particularly preferably 64 to 68%. When the fluorine content is in the above-defined specific content range, the fluoropolymer has good solubility in solvents. Further, when the fluoropolymer is contained as a component, it is possible to form a thin film that has excellent adhesion to various base materials, has a high level of transparency, has a low refractive index, and, at the same time, possesses satisfactorily high mechanical strength. Therefore, the mechanical properties such as scratch resistance of a surface with a thin film formed thereon can be very advantageously brought to a satisfactorily high level.

Regarding the fluorocopolymer, the molecular weight is preferably 5,000 to 200,000, particularly preferably 10,000 to 100,000, in terms of the number average molecular weight as determined using polystyrene as a standard. When a fluorocopolymer having the above molecular weight is used, the viscosity of the fluororesin composition is suitable and, thus, the fluororesin composition having suitable coating properties can be surely obtained. The refractive index of the fluorocopolymer per se is preferably not more than 1.45, particularly preferably not more than 1.42, still preferably not more than 1.40. When the refractive index exceeds 1.45, the use of this fluorocopolymer sometimes results in the formation of a thin film, from the resultant fluorocoating material, that has a low level of antireflection effect.

Alternatively, the lower-refractive index layer 6 may be formed of a thin film of SiO₂. In this case, the lower-refractive index layer 6 may be formed, for example, by vapor deposition, sputtering, or plasma CVD, or by a method in which an SiO₂ gel film is formed from a sol liquid containing SiO₂ sol. The lower-refractive index layer 5 may be formed of, in addition to SiO₂, a thin film of MgF₂ or other material. However, the use of a thin film of SiO₂ is preferred from the viewpoint of high adhesion to underlying layer. When plasma CVD is used among the above methods, the film formation is preferably carried out under such conditions that an organosiloxane is used as a starting gas and other inorganic vapor deposition sources are absent. Further, preferably, the object on which vapor deposition is carried out is maintained at the lowest possible temperature.

When the smoothing transparent resin layer and the anti-dazzling layer in the optical laminate according to the present invention are formed from an ionizing radiation curing resin, the ionizing radiation curing resin may be cured by a conventional method for curing an ionizing radiation curing resin composition, that is, by irradiation with electromagnetic waves such as ultraviolet light or visible light, or electron beams. For example, in the case of curing by electron beams, electron beams having an energy of 50 to 1000 KeV, preferably 100 to 300 KeV, emitted from various electron beam accelerators, such as Cockcroft-Walton accelerators, van de Graaff accelerators, resonance transformers, insulated core transformers, linear, dynamitron, and high-frequency electron accelerators may be used. On the other hand, in the case of curing by electromagnetic waves such as ultraviolet light or visible light, electromagnetic waves generated from light from ultrahigh pressure mercury lamps, high pressure mercury lamps, low pressure mercury lamps, carbon arc lamps, xenon arc lamps, and metal halide lamps may be used.

Thus, the optical laminate according to the present invention is formed. In this optical laminate, even when the transparent base material is formed of triacetylcellulose and is of a boat bottom shape in section and has streaks, the optical laminate does not suffer from problems including, for example, that difficulties are encountered in coating the anti-dazzling layer and the desired optical characteristics cannot be obtained. Therefore, the work for anti-dazzling layer formation can be carried out more stably at a higher speed with high efficiency, and, thus, even a large optical element can be produced with high efficiency. Further, the optical characteristics of the optical element can be regulated stably with higher accuracy.

### EXAMPLES

The following Examples and Comparative Examples further illustrate the present invention.

### Example 1

The present invention will be described in more detail with reference to the following Examples. The present invention is not limited to these Examples. “Parts” and “%” are by mass unless otherwise specified.

(Preparation of Coating Liquid for Base Material Smoothing Transparent Resin Layer 1)

14.2 parts by mass of urethane acrylate (UV7605B, manufactured by Nippon Synthetic Chemical Industry Co., Ltd., refractive index 1.51) as an ultraviolet curing resin, 27.8 parts by mass of 1,6-hexanedioldiacrylate (HDDA, manufactured by Nippon Kayaku Co., Ltd., refractive index 1.51) which is also an ultraviolet curing resin, 55.0 parts by mass of ethylcellosolve, 109.0 parts by mass of cyclohexanone, and 254.0 parts by mass of MIBK were thoroughly mixed together to prepare a coating liquid. This coating liquid was filtered through a 30-μm (pore diameter) polypropylene filter to prepare a coating liquid for a base material smoothing transparent resin layer.

(Preparation of Coating Liquid for Anti-Dazzling Layer)

95.0 parts by mass of pentaerythritol triacrylate (PETA, manufactured by Nippon Synthetic Chemical Industry Co., Ltd., refractive index 1.51) as an ultraviolet curing resin, 5.0 parts by mass of DPHA (manufactured by Nippon Synthetic Chemical Industry Co., Ltd., refractive index 1.51) which is also an ultraviolet curing resin, 10.0 parts by mass of an acrylic polymer (manufactured by Mitsubishi Rayon Co., Ltd., molecular weight 75,000), 5.0 parts by mass of Irgacure 184 (manufactured by CIBA-GEIGY Ltd.) as a photocuring initiator, 15.0 parts by mass of styrene beads (manufactured by Soken Chemical Engineering Co., Ltd., particle diameter 3.5 μm, refractive index 1.60) as light transparent fine particles, 0.01 part by mass of 10-28 (manufactured by The Inctec Inc.) as a leveling agent according to the present invention, 127.5 parts by mass of toluene, and 54.6 parts by mass of cyclohexanone were thoroughly mixed together to prepare a coating liquid. This coating liquid was filtered through a polypropylene filter having a pore diameter of 30 μm to prepare a coating liquid for an anti-dazzling layer.

(1) Coating of Base Material Smoothing Transparent Resin Layer

An 80 μm-thick triacetylcellulose film (TD80U, manufactured by Fuji Photo Film Co., Ltd.) was unwound in a roll form, and the coating liquid 1 for an anti-dazzling layer was coated onto the film to a thickness of 1.2 μm on a dry basis. The coating was dried at 70° C. for one min to remove the solvent. Further, ultraviolet light was applied at 70 mJ under nitrogen purge (oxygen concentration: not more than 200 ppm) to photocure the coating, thereby forming a base material smoothing transparent resin layer. The assembly thus obtained was wound.

(2) Coating of Anti-Dazzling Layer

The triacetylcellulose film coated with the base material smoothing transparent resin layer was again rewound. The coating liquid I for an anti-dazzling layer was coated to a thickness of 6.5 μm on a dry basis. The coating was dried at 110° C. for 70 sec. Further, ultraviolet light was then applied at 50 mJ to the coating under nitrogen purge (oxygen concentration: not more than 200 ppm) to photocure the coating and, thus, to form an anti-dazzling film coated with an anti-dazzling layer which was then wound.

(3) Saponification of Anti-Dazzling Film

The low-reflection anti-dazzling film thus obtained was treated as follows.

A 2.0 mol/l aqueous potassium hydroxide solution was prepared and was kept at 60° C. A 0.005 mol/l aqueous diluted sulfuric acid solution was prepared and was kept at 40° C. The anti-dazzling film was immersed in the aqueous sodium hydroxide solution for 2 min.

The anti-dazzling film was then immersed in water to thoroughly wash away the aqueous potassium hydroxide solution. Next, the anti-dazzling film was immersed in the aqueous diluted sulfuric acid solution for one min and was then immersed in water to thoroughly wash away the aqueous diluted sulfuric acid solution. Finally, the sample was satisfactorily dried at 100° C.

Thus, the saponified low-reflection anti-dazzling film was prepared.

This sample is designated as a sample of Example 1.

### Comparative Example 1

A sample of Comparative Example 1 was prepared in the same manner as in the sample of Example 1, except that the anti-dazzling layer was coated directly onto the triacetylcellulose film without coating the base material smoothing transparent resin layer.

### Comparative Example 2

A sample of Comparative Example 2 was prepared in the same manner as in the sample of Example 1, except that the thickness of the base material smoothing transparent resin layer on a dry basis was 0.2 μm.

### Comparative Example 3

A sample of Comparative Example 3 was prepared in the same manner as in the sample of Example 1, except that the thickness of the base material smoothing transparent resin layer on a dry basis was 3.0 μm.

### Comparative Example 4

A sample of Comparative Example 4 was prepared in the same manner as in the sample of Example 1, except that use was made of the following coating liquid for a base material smoothing transparent resin layer 2 having the same composition as that for the base material smoothing transparent resin layer in Example 1 except that the binder was changed to a high-functionality monomer.

(Preparation of Coating Liquid for Base Material Smoothing Transparent Resin Layer 2)

11.2 parts by mass of urethane acrylate (UV1700B, manufactured by Nippon Synthetic Chemical Industry Co., Ltd., refractive index 1.51) as an ultraviolet curing resin, 30.8 parts by mass of dipentaerythritol hexaacrylate (DPHA, manufactured by Nippon Kayaku Co., Ltd., refractive index 1.51) which is also an ultraviolet curing resin, 55.0 parts by mass of ethylcellosolve, 109.0 parts by mass of cyclohexanone, and 254.0 parts by mass of MIBK were thoroughly mixed together to prepare a coating liquid which was then filtered through a 30-μm (pore diameter) polypropylene filter to prepare a coating liquid for a base material smoothing transparent resin layer.

### Comparative Example 5

In Comparative Example 5, an electrically conductive inorganic pigment (ATO) was dispersed in the base material smoothing transparent resin layer.

A sample of Comparative Example 5 was prepared in the same manner as in the sample of Example 1, except that the following coating liquid for a base material smoothing transparent resin layer 3 was prepared and used.

(Preparation of Coating Liquid for Base Material Smoothing Transparent Resin Layer 3)

2.0 g of C-4456 S-7 (ATO-containing electrically conductive ink, average particle diameter of ATO 300 to 400 nm, solid content 45%, manufactured by NIPPON PELNOX CORP.) as an antistatic material, 2.84 g of methyl isobutyl ketone, and 1.22 g of cyclohexanone were added and were stirred, and the mixture was then filtered through a 30-μm (pore diameter) polypropylene filter to prepare a coating liquid 3 for an antistatic layer.

Table 1 below shows the results of Examples and Comparative Examples.

In Table 1, “streaks,” “curing,” “adhesion,” and “transmittance” were evaluated by the following methods.

1) Evaluation of Streaks:

The anti-dazzling film was evaluated for streaks in detail by subjecting the anti-dazzling film to 1) a transmission face test under a three band fluorescent lamp, and 2) a reflection face test under a three band fluorescent lamp in which a polarizing plate was applied to the anti-dazzling film so that the surface of the anti-dazzling film remote from the low-reflection anti-dazzling film surface faced the polarizing plate in a crossed nicol state, followed by a reflection face test under a three band fluorescent lamp.

x: Unacceptable level (streaks were visually observed at all angles and occurred in all width-wise directions)

Δ: Acceptable (streaks were observed at a certain angle or locally in a width-wise direction although the streaks were minor)

◯ to ⊚: Considerably good to very good (streaks were very minor or did not occur)

2) Evaluation of Curling:

The outside of the wound sample immediately after coating was taken off in a size of 150×150 mm and was allowed to stand at room temperature for one hr. For a corner of which the curl level was the largest among four corners of the sample, the height of the site from the horizontal plane was measured with a first-grade metal measure.

x: A height in curl site of not less than 15 mm

Δ: A height in curl site of 10 to 15 mm

◯: A height in curl site of not more than 10 mm

3) Adhesion:

1-mm cross-cuts were formed in the coating, and an industrial 24-mm cellophane tape manufactured by Nichiban Co., Ltd. was applied to the coating and was separated in a 90°-direction five times.

x: Separation occurred in some squares of cross-cuts.

Δ: Separation occurred in cross-cuts due to edge chipping.

◯: No separation occurred.

4) Transmittance:

The transmittance was measured with a reflectometer/transmissometer (model number: HR-100) manufactured by Murakami Color Research Laboratory in such a state that the coated surface faced the light source side.

TABLE 1

| | Streaks | Curling | Adhesion | Transmittance, % |
|---|---|---|---|---|
| Ex. 1 | ⊚ | ◯ | ◯ | ◯ (90.8) |
| Comp. Ex. 1 | X | ◯ | ◯ | ◯ (90.8) |
| Comp. Ex. 2 | Δ to X | ◯ | ◯ | ◯ (90.8) |
| Comp. Ex. 3 | Δ | Δ | Δ to X | ◯ (90.8) |
| Comp. Ex. 4 | ◯ | Δ | Δ to X | ◯ (90.8) |
| Comp. Ex. 5 | ◯ | ◯ | ◯ | X (89.4) |

1. An optical laminate comprising: a transparent base material; and an anti-dazzling layer provided on a surface of the transparent base material through a smoothing transparent resin layer for smoothing the surface of the transparent base material,
said transparent base material comprising triacetylcellulose, the thickness of the smoothing transparent resin layer being regulated to fall within a range of 0.5 to 2.0 μm, and the smoothing transparent resin layer being provided directly on the transparent base material without through any other layer.

2. The optical laminate according to claim 1, wherein said smoothing transparent resin layer comprises one or at least two resins selected from polyester resins, polyether resins, acrylic resins, epoxy resins, urethane resins, alkyd resins, spiroacetal resins, polybutadiene resins, and polythiol-polyene resins.

3. The optical laminate according to claim 1, wherein said smoothing transparent resin layer has been formed by coating the smoothing transparent resin on a surface of the transparent base material and then curing the coated smoothing transparent resin through the action of an ionizing radiation.

4. The optical laminate according to claim 1, wherein said anti-dazzling layer comprises inorganic or organic fine particles dispersed in a cured product of an ionizing radiation curing resin composition.

5. The optical laminate according to claim 1, which further comprise a lower-refractive index layer on the anti-dazzling layer.

6. An optical element comprising an optical laminate according to claim 1.

7. A polarizing plate comprising a polarizing element and an optical laminate according to claim 1 provided on a surface of the polarizing element so that the optical laminate on its side opposite to the anti-dazzling layer faces the polarizing element.

8. An image display device comprising a light transparent display, a light source device for illuminating the light transparent display from its backside, and an optical laminate according to claim formed on a surface of the light transparent display.

9. An image display device comprising a light transparent display, a light source device for illuminating the light transparent display from its backside, and a polarizing plate according to claim 7 formed on a surface of the light transparent display.
